(19) United States
(12) Patent Application Publication
(10) Pub. No.: US 2011/0122491 A1
(43) Pub. Date: May 26, 2011

(54) ILLUMINATION ARRANGEMENT FOR TIRF MICROSCOPY

(75) Inventor: Ralf WOLLESCHENSKY, Jena (DE)

(73) Assignee: CARL ZEISS MICROIMAGING GMBH, Jena (DE)

(21) Appl. No.: 12/968,788

(22) Filed: Dec. 15, 2010

Related U.S. Application Data
(63) Continuation of application No. PCT/EP2009/004267, filed on Jun. 12, 2009.

(30) Foreign Application Priority Data
Jun. 16, 2008 (DE) 10 2008 028 490.4

(51) Int. Cl. G02B 21/06

(52) U.S. Cl. 359/390; 359/385

(57) ABSTRACT

A TIRF illumination having a high axial resolution at low complexity. A TIRF illumination device is designed as a module and comprises an optical fiber and a collimating optic, wherein the collimating optic is mounted in front of a light discharge opening of the optical fiber, such that it collimates light exiting divergently from the optical fiber into a parallel light bundle, such that the excitation light can be applied to a sample outside of the detection beam path. The numerical aperture of the excitation is thus decoupled from the numerical aperture of detection, such that a standard microscope objective is sufficient for detection.

### CROSS-REFERENCE TO RELATED APPLICATIONS

The present patent application is a continuation of International application No. PCT/EP2009/004267, filed Jun. 12, 2009, published in German, which is based on, and claims priority from, German Application No. 10 2008 028 490.4, filed Jun. 16, 2008, both of which are incorporated herein by reference in their entireties.

### BACKGROUND OF THE INVENTION

(1) Field of the Invention

The invention concerns an illumination arrangement for TIRF microscopy.

(2) Description of Related Art Including Information Disclosed Under 37 CFR 1.97 and 1.98

Illumination for a total internal reflection fluorescence measurement has previously been done by means of a prism on the side facing away from the microscope objective, wherein the sample to be investigated must be prepared with great effort on the prism. TIRF illumination alternatively takes place through the microscope objective, requiring a high numeric aperture, and thus a complex objective, due to the large angle of incidence required.

Microscopy with application of the-called total internal reflection fluorescence is a special form of fluorescence microscopy. It is, for example, disclosed in WO 2006/127692 A2, incorporated by reference. FIG. 1, marked prior art, clarifies the context. The fluorophore F₀ specimen 14 is excited by means of an evanescent illumination field E solely in a thin layer behind the boundary surface between the cover glass 9 and the specimen 14 for fluorescence F₁. The evanescent illumination field E is produced in the specimen 14, in which the excitation radiation T inside the cover glass 9 is conducted at an angle θ_{c}, which leads to total internal reflection, at the boundary surface of the cover-glass probe.

Because only the thin layer is excited by the fluorescence, a specially high axial resolution can be attained. The optical axial resolution of a TIRF microscope arises from the penetration depth d of the evanescent field in the specimen. Depending on the angle of incidence θ, the axial solution results as:

$$d = \frac{λ}{4 π \sqrt{{n}_{1}^{2} {sin}^{2} θ - {n}_{2}^{2}}} ,$$

where λ is the light wavelength, n₁ is the index of refraction of the cover glass, and n₂ is the index of refraction of the specimen medium. FIG. 2 presents, by way of example, the axial resolution d of a TIRF microscope as a function of the angle of incidence θ for different wavelengths. It is shown that with an increasing angle of incidence θ, the penetration depth decreases, and thus the optical axial resolution d of the microscope increases. For axial high-resolution images, a particularly larger angle of incidence is needed for the excitation radiation.

Two types of TIRF illumination are known in the prior art, and are represented schematically in FIGS. 3A and 3B. The partial schematic FIG. 3A shows an arrangement with TIRF illumination by means of a prism 19. The fluorescence is collected through the objective 5 and is formed at a CCD camera (not shown). As can be seen, the TIRF illumination T is performed on the side pointing away from the objective 5. This has the disadvantage that the specimen to be studied 14 has to be prepared on the prism 19, because the evanescent lighting field is excited at the boundary surface between the prism 19 and the specimen 14. This type of preparation is expensive. In contrast thereto, specimens are prepared as a rule on a thin cover glass.

In the second type of TIRF illumination according to partial schematic FIG. 3B, disclosed, for example in FIG. 9 of WO 2006/127692 A2, the specimen 14 can be prepared by a standard procedure on a cover glass 9, because here the TIRF illumination is performed through the microscope objective 5. This arrangement, however, has the disadvantage that the microscope objective 5 has to posses a high numerical aperture in order to make it possible to have a large angle of incidence necessary for high resolution for the excitation light T. As a result, there are increased demands upon the glasses used, whereby the number of glass types available is reduced. For example, immersion media and front lenses with a correspondingly higher index of refraction have to be used. In addition, the number of lenses for image correction has to be increased, as a rule, so that manufacturing expense rises and transmission decreases. If the specimen for the TIRF excitation is illuminated with different light wavelengths, so must the angle of incidence, in order to guarantee a high resolution, for all the wavelengths to be identical, the complexity of the microscope and with it its manufacturing expense increase further.

The present invention is based on the problem of presenting an arrangement and a procedure which make possible, for specimen 14 to be prepared on a cover glass and the inclusion of TIRF illumination with high axial resolution at low cost.

### BRIEF SUMMARY OF THE INVENTION

The invention solves the prior art problem by means of a TIRF illumination device for a microscope, exhibiting a light-wave conduit and a collimation lens, whereby the collimation lens is fastened in front of the light discharge opening of the light-wave conduit so that it collimates the light emerging divergently from the light-wave conduit to form a light bundle.

According to the invention, the TIRF illumination device is constructed as a module and has a light-wave conduit and a collimation lens, whereby the collimation lens is attached in front of a light discharge opening of the light-wave conduit such that it collimates light emerging divergently from the light-wave conduit to form a light bundle. In accordance with the invention, a module is an independent piece of equipment for illumination, which is to be used with its own light source that emits at least one fluorescence excitation wavelength into the light-wave conduit, and is used beside a detection microscope.

The invention also comprises a procedure for TIRF excitation in a specimen, whereby a collimated light ray is introduced as TIRF illumination outside of a detection beam path to a specimen. Preferably, the collimated light ray is passed on the same specimen side as the detection beam path to the specimen. However, the introduction of the specimen on the side pointing away from the objective is also possible.

By means of such an illumination module or such a procedure, the numerical aperture of the excitation is disassociated from the numerical aperture of detection. As a result, the numerical aperture of the illumination, in spite of the illumination through a cover glass, is particularly chosen to be greater than numerical detection apertures that in essence are provided by the pairing of a front lens and an immersion medium of the microscope objective. Thus regarding the optical construction, the usual microscope objective can be used for fluorescence detection, which is less prone to aberrations elicited in the preparation. This makes it possible, at low cost, to achieve a high optical resolution. Through the collimation, a more uniform angle of incidence is ensured for this, also at low cost with several light-waves.

The collimation lens is preferably constructed as a gradient lens. This makes possible a compact construction taking up little space for the illumination device. For this purpose, the end of the light-wave conduit is connected directly to the collimation lens.

In preferred embodiments, the collimation lens and at least the end of the light-wave conduit are enclosed in a housing. The illumination device is thereby easily handled and is attached in alignment with the specimen. The housing can in particular serve to attach the light-wave conduit and/or the collimation lens.

In a first embodiment, the housing can preferably be constricted in sections at the collimation lens. In connection with a correspondingly formed support, the position of the illumination device can be defined by the support.

In a second embodiment, the housing can preferably be rod-shaped. Preferably, the housing is then provided with a stop element. In connection with a support with a complementary stop element, the position of the illumination device is defined by the support.

Preferably, a—for example—rod-shaped glass adapter is arranged at the collimation lens on its side pointing away from the light discharge opening. If the cross-section of the glass adapter fits the contours of the housing and the glass adapter is adjacent and touching on all sides to the housing, then it protects the collimation lens from contamination. Appropriately, the material of the glass adapter exhibits an index of refraction that is as near as possible identical to the index of refraction for the immersion medium used. As a result, light refraction does not occur at the boundary surface between the glass adapter and the immersion medium for light refraction, but the collimated light beam maintains its direction, even if the boundary surface is not perpendicular to the dispersion direction. As a consequence, the end of the TIRF illumination device, at which the collimated light beam emerges, can be arbitrarily formed. The glass adapter can be arranged at a distance from the collimation lens or disposed immediately thereupon. The collimated bundle is not influenced thereby.

Embodiment shapes are especially compact and flexible in handling, in which the light-wave conduit consists of exactly one light-conducting fiber.

Preferably, the illumination device has a diameter transverse to the optical axis of the collimation lens with a maximum of 0.7 mm. Positioning beside the microscope objective and relative to the specimen is thus very flexible.

Appropriately, the focal length of the collimation lens is measured such that a cross-section of the light bundle corresponds approximately to a diameter of a field of view for a microscope objective. Thus the field of vision is utilized as effectively as possible.

In a preferred embodiment shape, the light-wave conduit consists solely of one or several polarization-capable, single-mode light-conducting fibers.

The modular TIRF illumination device is amended by a microscope objective with a support means for a collimation lens and for a light-wave conduit, whereby the collimation lens can be position in front of the light-discharge opening of the light-wave conduit so that it collimates the light emerging divergently from the light-wave conduit to a light bundle, whereby the support means is constructed such that the collimated light bundle crosses the optic axis of the microscope objective at an angle that is greater or equal to the angle of total reflection. With such a support means the radiation direction of collimated TIRF illumination can be defined with respect to the microscope objective and relative to the specimen with great precision.

Preferably the support means is formed by a recess for the reception of a modular TIRF illumination device described above in a mount of the microscope objective and/or in a front lens of the microscope objective. This makes possible the definition of the position at little expense. The recess can thereby pass through the front lens of the microscope objective and in particular end in the edge region of the front lens.

Alternatively, the collimation lens and a connection port for the light-wave conduit is attached through the support means, in particular, permanently. In this way, the light-wave conduit can be removably connected to the connection port. In this form, no housing is necessary. Handling is simple because the light-wave conduit merely has to be connected to the connection port for TIRF illumination.

In general, the collimated light beam can be passed through the microscope objective, in particular through its mount and/or front lens to the specimen.

In any case, a glass adapter can be disposed at the collimation lens on its side pointing away from the light discharge opening. As with the modular illumination device, the collimation lens is protected from contamination. If the material of the glass adapter exhibits an index of refraction as nearly identical as possible to the index of refraction of the immersion medium to be used, then light refraction does not occur at the boundary surface between the glass adapter and the immersion medium for light refraction. In this way, the shape of the glass adapter, from which the collimated light emerges, can be adjusted, for example to the curve of the front-lens surface or to the shape of the objective mount. In particular, the glass adapter can thus seal flush with the surrounding front lens or the surrounding mount. The glass adapter can be arranged at a distance from the collimation lens or be disposed directly thereon. The collimated bundle is not influenced thereby.

In a further embodiment, the support can preferably be installed such that between the light bundle and the optic axis of the microscope objective, different angles, which are greater than or equal to the angle of total reflection, can be used. This makes possible, on the one hand, the optimization of the total reflection depending on the excitation shaft length and, on the other hand, a variable use of the penetration depth of the excitation light on the specimen.

The invention also includes a microscope with a microscope objective according to the invention and in particular with a TIRF illumination module according to the invention. The illumination device and the microscope objective according to the invention can be used in all microscopic procedures, for which TIRF excitation is advantageous. They are especially suitable for photo-activated localization microscopy (PALM), disclosed for example in WO 2006/127692 A2.

The invention will be further explained by the following, using the embodiment examples.

### BRIEF DESCRIPTION OF THE SEVERAL VIEWS OF THE DRAWINGS

In the drawings show:

FIG. 1 is a schematic diagram showing the manner of functioning of TIRF,

FIG. 2 is a graph showing the penetration depth, as a function of the angle of incidence at three wavelengths,

FIGS. 3A and 3B are schematic diagrams of TIRF illumination possibilities according to prior art,

FIGS. 4A and 4B are schematic diagrams showing a TIRF illumination device according to the invention,

FIGS. 5A and 5B are schematic drawings of a further TIRF illumination device according to the invention,

FIG. 6 is a schematic drawing of a microscope objective according to the invention with a TIRF illumination device according to the invention,

FIGS. 7A, 7B and 7C are schematic drawings for additional arrangement possibilities on the microscope objective for the collimation lens and light wave conduit,

FIGS. 8A and 8B are schematic drawings for additional arrangement possibilities on the microscope objective for the embodiments using a glass adapter,

FIG. 9 is a schematic representation of the ray paths of a light microscope and of the TIRF illumination device with light sources, and

FIG. 10 is a schematic representation of the ray paths of a scanning microscope and the TIRF illumination device.

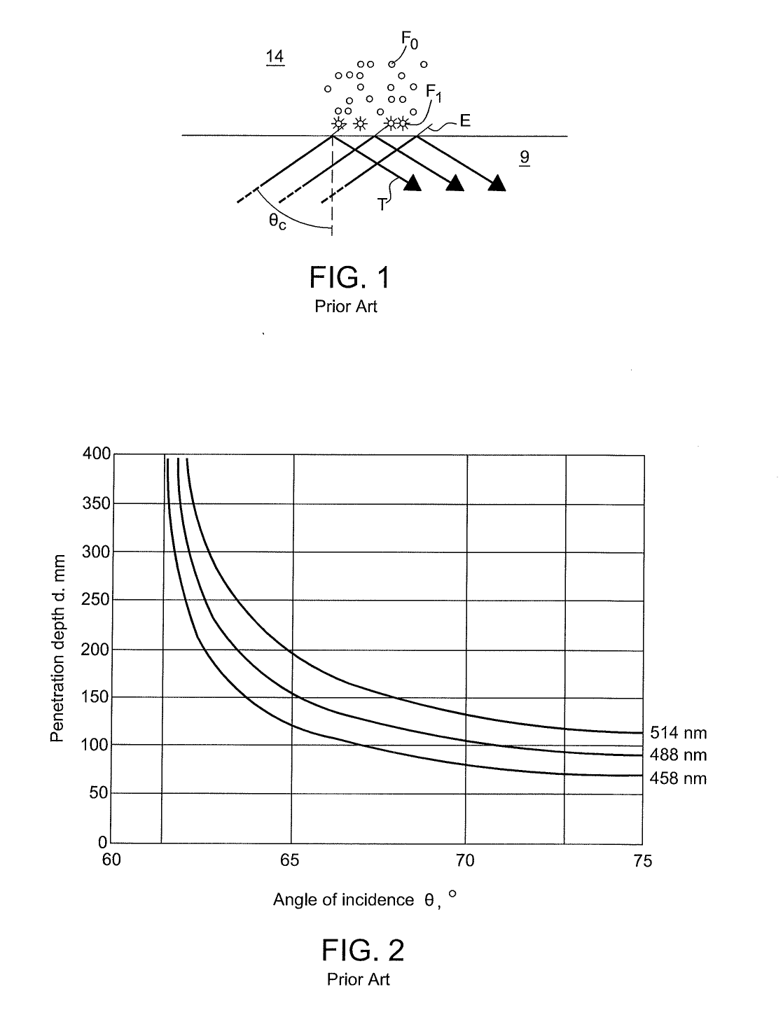

The reference numbers agree for the parts in all the drawings.

### DETAILED DESCRIPTION OF THE INVENTION

In describing preferred embodiments of the present invention illustrated in the drawings, specific terminology is employed for the sake of clarity. However, the invention is not intended to be limited to the specific terminology so selected, and it is to be understood that each specific element includes all technical equivalents that operate in a similar manner to accomplish a similar purpose.

In order to achieve a specified axial resolution, the collimated beam of the TIRF excitation illumination must be shone in at an incidence angle θ given by the formula above onto the boundary surface between the specimen and the cover glass. In accordance with the invention, it was recognized that through a small, separate illumination module for TIRF excitation, that the numerical aperture of the excitation can be disassociated with the numerical detection aperture.

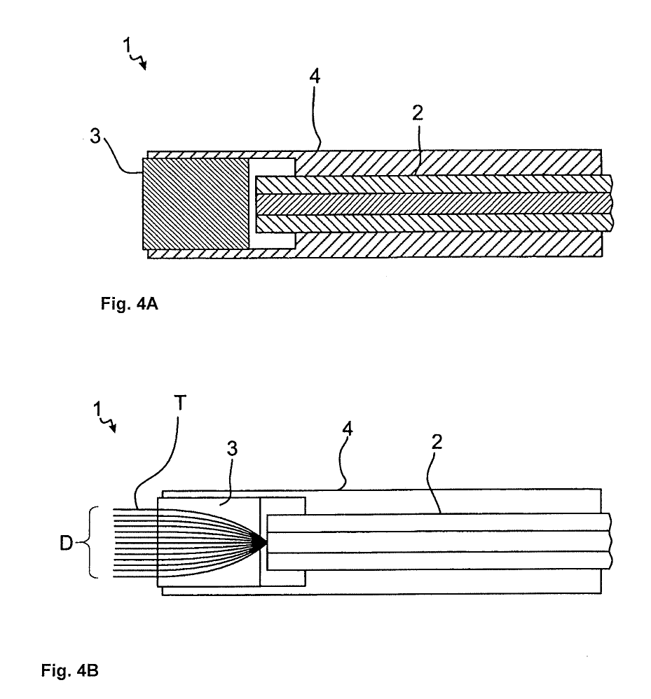

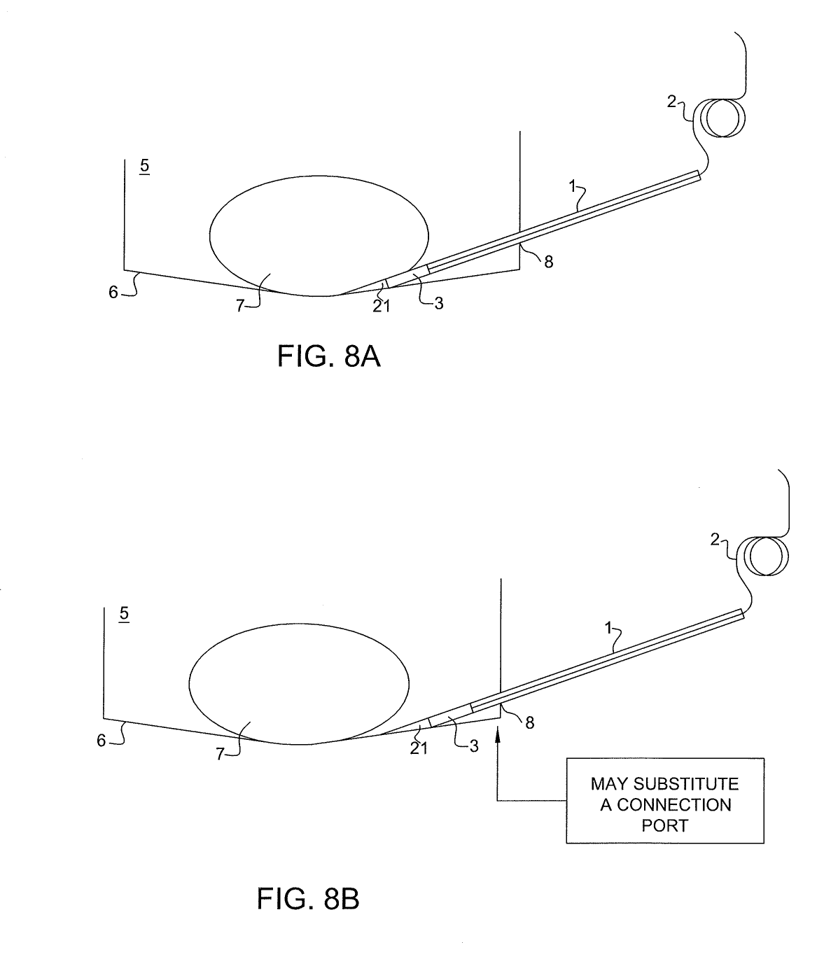

Accordingly, FIGS. 4A and 4B schematically show a TIRF illumination rod 1, which consists of a light-wave conduit 2 in the form of a glass fiber, a collimation lens 3, and a housing 4. FIG. 4A shows a partial cross-section and FIG. 4B shows the effect of the collimation lens 3 on the TIRF excitation radiation T. The glass fiber 2 is, for example, a single-mode variant and is polarization-preserving. By way of example, with reference to FIG. 8, the light-inlet opening 25 of the glass fiber 2 can, for example using a coupler 13, be connected to a laser light-source LQ1, which emits a fluorescence-exciting wavelength. The housing 4 encapsulates the TIRF illumination rod 1 in the area of the collimation lens 3 in a fluid-tight manner, so that, in particular, no immersion medium can penetrate the housing. Also, at the opposite end 26, the housing can be constructed around the inlet portion of the light-wave conduit 2 in a fluid-tight manner.

The light beam emerging divergently from the light discharge opening of the glass fiber 2 is directed by means of the collimation lens 3 to a parallel beam bundle T. The focal length of the collimation lens 3 is so adjusted, for example, that the bundle cross-section D approximately corresponds to the field of view of a microscope objective to be used on the specimen. Especially suitable for collimation of the light bundle from the glass fiber 2 is the application of a so-called GRIN optics (gradient index), because here the glass fiber 2 can be connected directly to the gradient lens (i.e. spliced). The housing 4, which includes the whole arrangement, is a rod ferrule made, for example, of metal. The overall arrangement of the TIRF illumination rod 1 in a preferred embodiment has a diameter of approximately 0.6 mm.

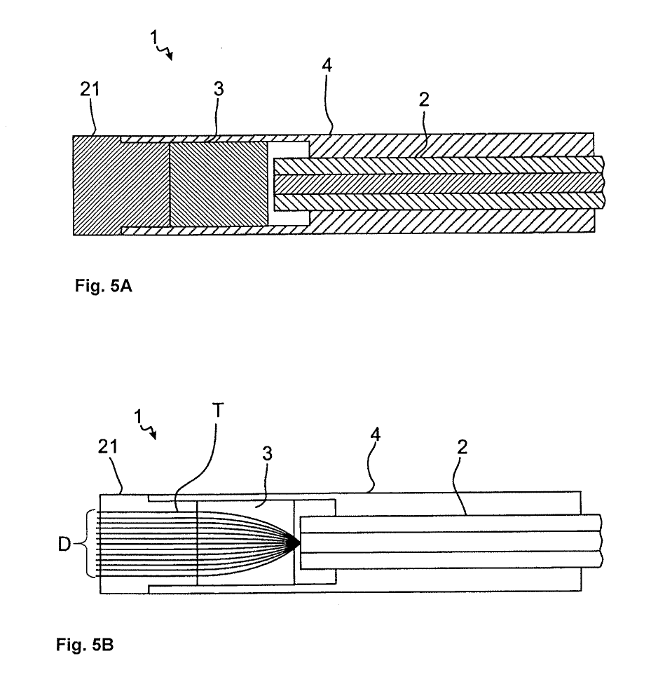

FIGS. 5A and 5B, compared to FIGS. 4A and 4B, represent a further embodiment of the TIRF illumination rod 1 including a number of parts. FIG. 5A shows a partial cross-section and FIG. 5B shows schematically the path of the TIRF excitation radiation T. A glass adapter 21 with the same diameter as the housing 4 has all adjacent sides flush and in contact with the housing 4. The glass adapter is arranged to protect the collimation lens 3. It encapsulates the TIRF illumination rod 1 in the area of the collimation lens 3 in a fluid-tight manner. The glass adapter 21 has the same index of refraction as an immersion medium to be used during a TIRF measurement. The glass adapter 21 has no optical effect; the collimated light beam remains collimated.

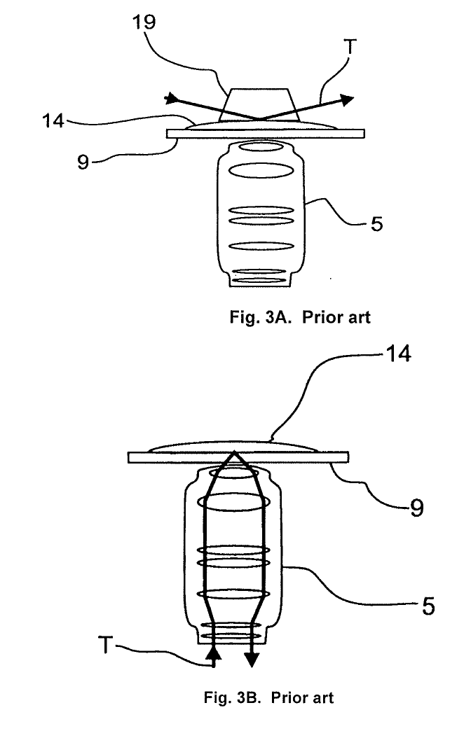

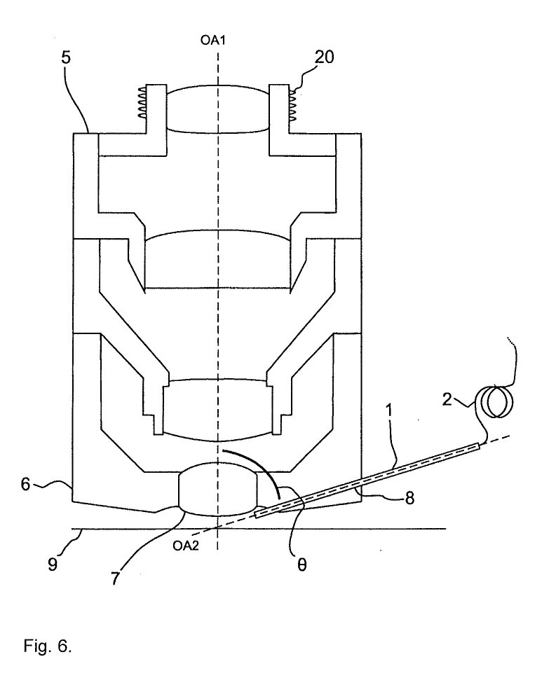

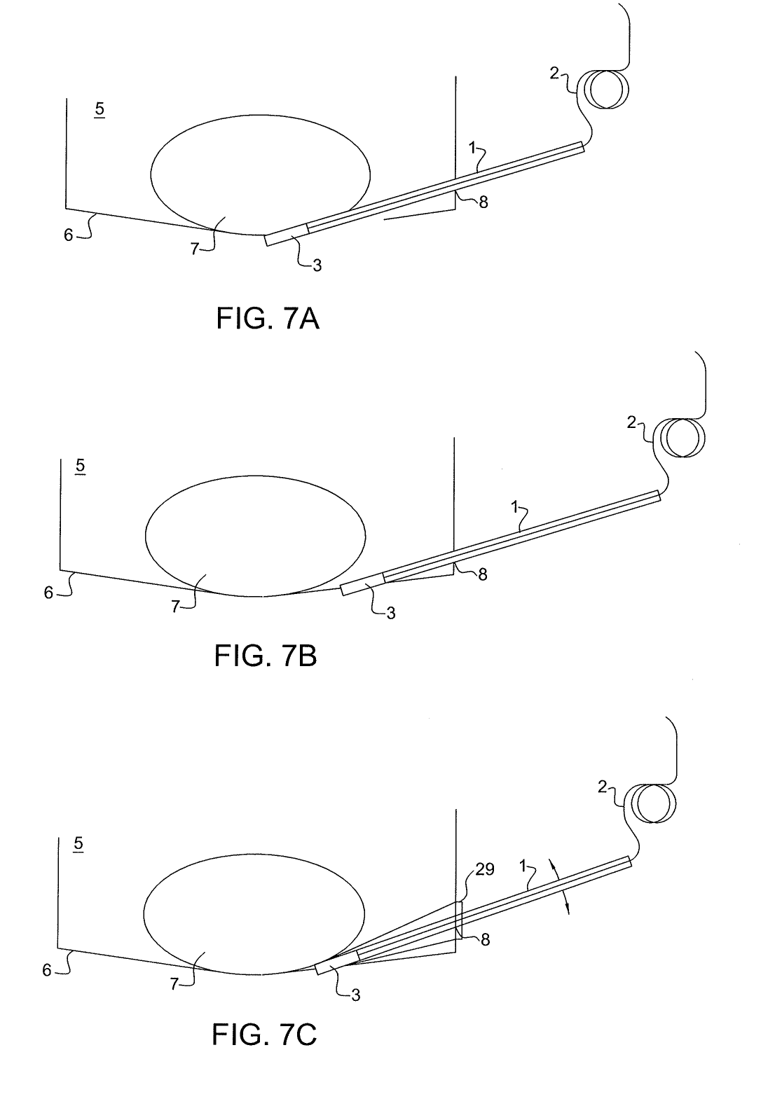

FIG. 6 shows the arrangement of the TIRF illumination rod 1 on a microscope objective 5, whereby it can be omitted on a complex objective, as in FIG. 3B. The rod 1 is arranged on the objective 5 at an angle θ. For this purpose, the mount 6 of the front lens 7 is provided with a corresponding recess 8 in the form of a hole drilled in the mount to correspond to the diameter of the rod 1. In an alternative embodiment shown in phantom, the recess also passes through the front lens 7 as shown in FIG. 7A. The TIRF illumination rod 1 is removably fastened in the recess 8, for instance by additional bearing elements 27. The objective 5 is fastened in a customary way and manner to a conventional microscope stage (not depicted) by the objective screws 20.

In an alternative embodiment shown in FIG. 7C, the recess 8 may be larger and can exhibit an adjustable support for the TIRF illumination rod 1, so that the angle θ can be set to different values. In each case, the recess must be tight with the TIRF illumination rod 1 installed relative to the immersion medium (not depicted) between the objective 5 and cover glass 9. For the use of the objectives 5 without the TIRF illumination rod 1, an appropriate stop (not depicted) is provided.

The microscope objective 5 therefore defines a first optic axis OA1, while the collimation lens 3 of the TIRF illumination rod 1 defines a second optic axis OA2 for the TIRF excitation. The specimen 14 is prepared in the immediate vicinity of the cover glass 9. The first and the second optic axes are at an angle θ to one another, which is greater than the maximum angle given by the numerical aperture of the objective 5 and greater than the critical angle θ_{c}, from which total reflection results, depending on the index of refraction, so that an evanescent field exists at the boundary surface between cover glass 9 and specimen.

In an alternative embodiment form, the collimation lens 3 and a connector can be fastened at/in the objective 5 in support means, for instance a recess 8 as described above. The light-wave conduit 2 can then be unfastened by using the connection port, while the collimation lens and the connection port remain on the objective 5.

In FIGS. 8A and 8B, two examples for the support of a TIRF illumination rod 1 with a glass adapter 21 are schematically represented. In FIG. 8A, the recess 8 goes through the mount 6 and the front lens 7 of the microscope objective 5. The glass adapter 21 exhibits the same index of refraction as the front lens 7 and is shaped in such a way that it does not protrude from surface of the front lens 7. In FIG. 8B, the recess 8 only goes through the mount 6. The glass adapter 21 also exhibits the same index of refraction as the front lens 7. It is shaped so that it does not protrude from the surface of the mount 6. In both cases, instead of a modular rod 1, the collimation lens 3 and the glass adapter 21 are fastened in the objective 5. A housing is then not required. To connect the light-wave conduit, a connection port is then appropriately provided. Typically, the glass adapter 21 is disposed as depicted at the lower end of the recess 8, while the collimation lens 3 with the connection port is disposed at the upper end of the recess 8.

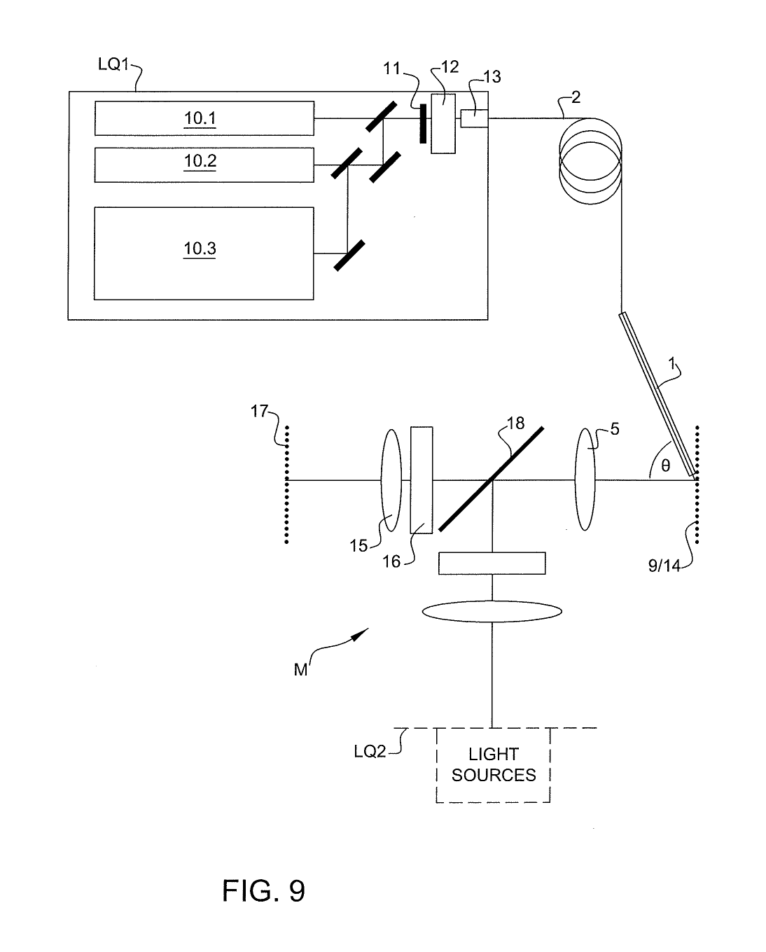

FIG. 9 shows, schematically, the optical arrangement of the objective 5 with TIRF illumination rod 1 on a microscope M. Light from various lasers 10.1,10.2, 10.3 is joined together in the light source LQ1 above a light shutter and a reducer 12 by means of a coupler 13 and the glass fiber 2. The glass fiber 2 leads to the TIRF illumination rod 1.

This is joined to the objective 5 as pictured, whereby the incidence angle θ is chosen so that an evanescent beam field exists at the boundary surface between cover glass 9 and specimen 14. Through the evanescent field, molecules are excited to fluorescence in the area of the boundary surface. The specimen fluorescence is collected with the microscope objective 5 and by means of a tube lens 15, a filter 16 is formed for suppressing the excitation radiation at a CCD camera 17, whereby the camera is located in an intermediate image of the microscope M. In addition, for TIRF excitation through the illumination rod 1, light sources (shown in phantom) are coupled from a further light-source module LQ2 by means of a dichroic beam splitter 18.

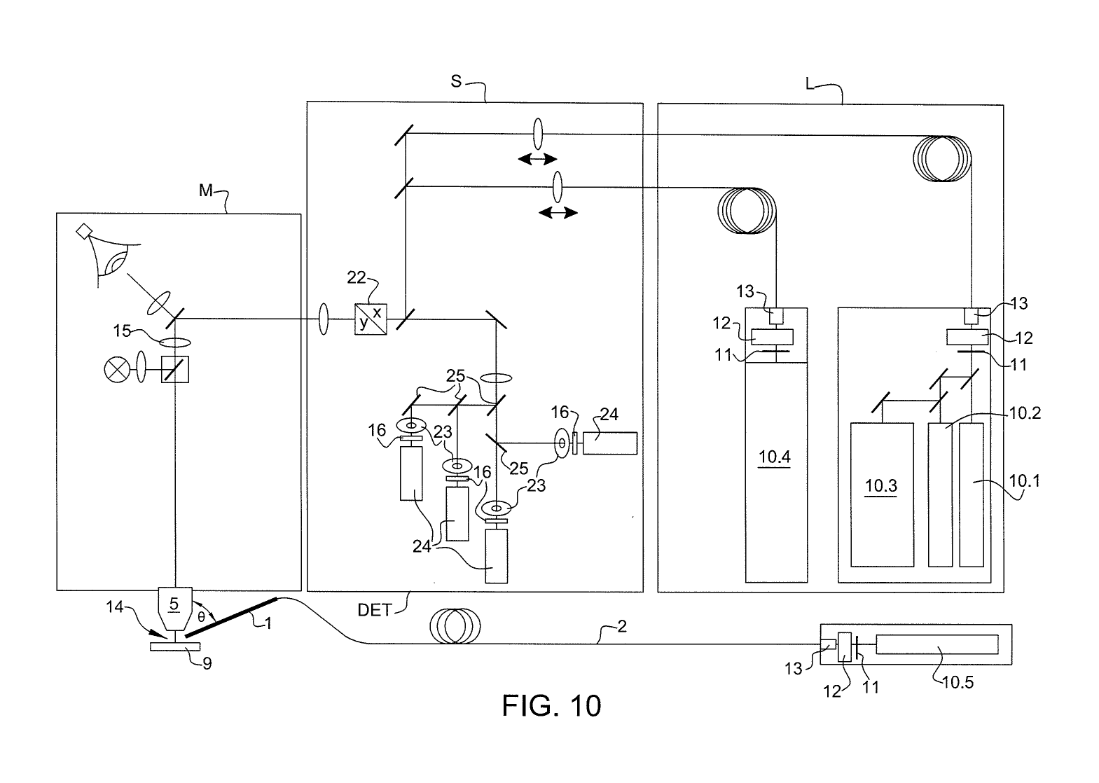

In FIG. 10, the application of a TIRF illumination rod 1 with an individual excitation laser 10.5 on a laser scanning microscope (LSM) is represented, in which the focus volume can be moved across the specimen by means of two scanning mirrors 22. The LSM is put together modularly from an illumination module L, a scanning module S, a detection module DET, and a microscope unit M. The detection module DET exhibits several detection channels with one hole aperture 23, one filter 16, and one photomultiplier 24 each, which are separated by a color splitter 25. Instead of a hole aperture, a slit aperture can also be used, for example, with linear illumination.

In both FIG. 9 and FIG. 10, instead of a TIRF illumination rod 1, the collimation lens 3 can be disposed with a connection port directly on objective 5.
The use of the TIRF illumination device does not absolutely require the use of a microscope objective with a special recess. The TIRF illumination module can rather also be aligned with a separate support relative to the objective and for the specimen. A TIRF illumination rod 1 can, for example, be replaced by a prism in a use according to FIG. 3A. The specimen preparation is then clearly simplified. In each case, the tip of the TIRF illumination module must lie in an immersion medium in order to ensure the passage of the excitation light into the cover glass. The immersion medium must be appropriately provided with a casing. An opening is provided in the casing for passing the TIRF illumination device through.

### REFERENCE LIST

1 TIRF illumination rod
2 Glass fiber
3 Collimation lens
4 Housing
5 Microscope objective
6 Mount
7 Front lens
8 Recess
9 Cover glass
10.1,10.2,10.3,10.4,10.5 Laser
11 Light shutter
12 Reducer
13 Coupling fiber
14 Specimen
15 Tube lens
16 Filter
17 CCD camera
18 Dichroic beam splitter
19 Prism
20 Thread
21 Glass adapter
22 Scanning mirror
23 Hole aperture
24 Photomultiplier
25 Light Inlet Opening
26 Opposite End
27 Bearing Elements
F₀ Fluorophore (ground state)
F: Fluorophore (excited state)
T TIRF excitation light
D Bundle cross-section
LQ2 Second light source
OA2 Second optic axis
θ Angle
E Evanescent lighting field
M Microscope
LQ1 First light source
L Illumination module
S Scanning module
DET Detection module

What is claimed is:

1. A modular TIRF illumination device for a microscope with an objective lens, the TIRF illumination device comprising:
an optical fiber having a light discharge opening; and
a collimation lens fastened in front of the light discharge opening of the light-wave conduit so that the collimation lens collimates the light emerging divergently from the light-wave conduit to form a light bundle emerging from the collimation lens.

2. The TIRF illumination device according to claim 1, wherein the collimation lens is a gradient lens.

3. The TIRF illumination device according to claim 1, further comprising a housing for enclosing the collimation lens and at least the light discharge opening of the light-wave conduit.

4. The TIRF illumination device according to claim 3, wherein the housing is in sections at the collimation lens.

5. The TIRF illumination device according to claim 3, wherein the housing is rod-shaped.

6. The TIRF illumination device according to claim 5, wherein the housing is provided with a bearing element.

7. The TIRF illumination device according to claim 3, further comprising a glass adapter disposed at the side of the collimation lens pointing away from the light discharge opening.

8. The TIRF illumination device according to claim 1, wherein the light-wave conduit comprises one light-conducting fiber.

9. The TIRF illumination device according to claim 1, wherein a diameter measured transverse to the optic axis of the collimation lens has a maximum value of 0.7 mm.

10. The TIRF illumination device according to claim 1, wherein a focal length of the collimation lens is chosen so that a cross-section of the light bundle corresponds approximately to the diameter of a field of view of the objective lens.

11. The TIRF illumination device according to claim 1, wherein the light-wave conduit consists of at least one polarization-preserving, single-mode light-conducting fiber.

12. A microscope objective for use with a collimation lens and a light-wave conduit, the microscope objective comprising:
an objective having a front lens; and
a support means for the collimation lens and for the light-wave conduit, whereby the collimation lens can be positioned in front of a light discharge opening of the light-wave conduit so that it collimates light emerging divergently from the light-wave conduit to a light bundle, whereby the support means causes the collimated light bundle to cross the optic axes of the objective at an angle that is greater than or equal to the angle of total reflection.

13. The microscope objective according to claim 12, further comprising:
a mount for holding the front lens, the support means being formed by a recess in the objective to receive a modular TIRF lighting device consisting of the collimation lens and the light-wave conduit into the mount of the objective and/or in the front lens of the objective.

14. The microscope objective according to claim 12, further comprising a connection port for the light-wave conduit, wherein the collimation lens and the connection port are fastened by the support means, whereby the light-wave conduit can be connected removably to the connection port.

15. The microscope objective according to claim 12, wherein the support means is installed so that different angles are usable between the light bundle and the optic axis of the microscope objective, and the different angles are each greater than or equal to the total reflection angle.

16. A method for TIRF excitation in a specimen, the method comprising the steps of:
passing a light through an optical fiber having a light discharge opening and then through a collimation lens fastened in front of the light discharge opening of the light-wave conduit so that the collimation lens collimates the light emerging divergently from the light-wave conduit to form a light bundle emerging from the collimation lens.

17. The method according to claim 16, whereby photo-activated localization is performed.

18. The according to claim 16, further comprising the steps of passing the collimated light beam as TIRF illumination outside of a detection beam path onto the specimen.

19. The method according to claim 18, in which the collimated light beam passes onto the specimen on the same specimen side as the detection beam path.

20. The method according to claim 18, in which the collimated light beam passes through a microscope objective.
